(19) United States
(12) Patent Application Publication
(10) Pub. No.: US 2015/0358416 A1
(43) Pub. Date: Dec. 10, 2015

(54) METHOD AND APPARATUS FOR ADAPTING CUSTOMER INTERACTION BASED ON ASSESSED PERSONALITY

(71) Applicant: PERSUASIVE LABS INC., Vancouver (CA)

(72) Inventors: Michael Gariepy, Vancouver (CA); Dane A Ellis, Calgary (CA)

(21) Appl. No.: 14/763,040

(22) PCT Filed: Jan. 23, 2014
(86) PCT No.: PCT/CA2014/050047

§ 371 Date: Jul. 23, 2015

Related U.S. Application Data
(60) Provisional application No. 61/755,767, filed on Jan. 23, 2013.

(51) Int. Cl. H04L 29/08; H04L 12/58

(52) U.S. Cl. CPC H04L 67/22; H04L 51/32

(57) ABSTRACT

A method and apparatus for guiding interaction with a subject person, for example a customer. Data relating to prior social activity of the subject person is obtained, for example from stored emails, social media, and the like. Based on the data, a determination is made of a set of personality traits of the subject person, a social networking status of the subject person, or both. The determination may include whether the subject person is a potential advocate or detractor, or a potential impact of the subject person. The subject person is categorized based on the determination, and a set of parameters for guiding interaction with a subject person based on the categorization is provided. Proposed outgoing communication can also be assessed for personality traits being conveyed, and noncompliant traits can be automatically identified and adjusted.

### CROSS-REFERENCE TO RELATED APPLICATIONS

This application claims the benefit and priority of U.S. Provisional Application 61/755,767, filed Jan. 23, 2013. The foregoing application is incorporated by reference herein in their entirety.

### FIELD OF THE TECHNOLOGY

The present technology relates in general to automated assessment of factors such as personality type and social network status, and in particular to a method and apparatus for automatically guiding communication based on an assessment of such factors.

### BACKGROUND

On a day-to-day basis, large amounts of data are generated by various people through interaction with social networking sites and tools, email correspondence, social media posts, and the like. A portion of this data relates to interaction of customers or potential customers with companies providing products or services. Much of the data is publicly available or even stored for a period of time, and represents an opportunity to perform data mining to determine various information, including personal information about the people generating the data. Data mining techniques can be used to gain marketplace advantages. By looking through potentially large quantities of data, it is possible to accurately predict certain aspects of purchasing tendencies, people/product fits, and the like, based on previous consumption patterns and other metrics. Marketers and advertisers use this type of information to target specific audiences for their products, and social media has been a great enabler of this information revolution.

Personality theory is a widely studied subfield within psychology. Industrial, cognitive, and social psychologies have all attempted to measure aspects of personality with success. The following is an excerpt from Ellis and Abrams (2007) “Personality Theories: Critical Perspectives”. “Personality theory is the study of the ways in which people differ from one another. It focuses on those differences in the way people think, behave, and process information. And it is these differences that define personality itself. Despite this working definition, personality is difficult to define precisely, as the many experts in the field of personality psychology differ in their standards and instruments of measurement.” Personality is a widely observed and discussed topic in the public forum. Most people have applied some type of personality theory to their own lives, or their own interpersonal relationships, to some extent. This application is often inadvertent, but the selection of mates, friends, and employees are often the result of inferring and applying personality nuances to individuals.

In academics and business, several taxonomies for measuring personality have emerged, including methods like the Big Five Factor Model and Myers-Briggs. These taxonomies have been widely studied and documented in the pursuit of greater understanding of personality.

Semantic engines have been proposed, in which natural language programming rules are used to help determine meaning behind plain text—such as tense and intonation. These engines, combined with other metrics, can reveal insights from data sets, including the personality traits of individuals.

The presence or absence of clients and the ability to communicate a message to potential clients determines whether potential clients become actual clients to sustain a business. Communication within the business forms the outward message. The process of managing the interactions between business and its consumers is often referred to as customer relationship management.

However, despite the above, there remains a need for a method and apparatus for automatically guiding communication with a subject person such as a customer based on assessed personality type, social network status, or both.

This background information is provided for the purpose of making known information believed by the applicant to be of possible relevance to the present technology. No admission is necessarily intended, nor should be construed, that any of the preceding information constitutes prior art against the present technology.

### SUMMARY OF THE TECHNOLOGY

An object of the present technology is to provide method and apparatus for adapting customer interaction based on assessed personality. In accordance with an aspect of the present technology, there is provided a method for guiding interaction with a subject person, the method comprising: obtaining, by a computer, data relating to prior social activity of the subject person; automatically making a determination, by a computer, of one or both of: a set of personality traits of the subject person; and a social networking status of the subject person, wherein said determination is made at least in part on the basis of said obtained data; automatically categorizing, by a computer, the subject person based on said determination; and automatically providing, by a computer, a set of parameters for guiding interaction with a subject person based on said automatic categorization.

In accordance with another aspect of the present technology, there is provided a method for guiding interaction performed by an agent within a predetermined organization, the method comprising: receiving, by a computer, a proposed communication submitted by the agent; automatically assessing, by a computer, a set of personality traits conveyed by said communication; automatically comparing, by a computer, said assessed set of personality traits to a target set of personality traits prescribed by the organization; automatically identifying, by a computer, one or more phrases within the communication which cause the assessed set of personality traits to differ from the target set of personality traits; and automatically providing, by a computer, feedback to the agent to adjust the identified one or more phrases.

In accordance with another aspect of the present technology, there is provided an apparatus configured for guiding interaction with a subject person, the apparatus comprising: a data acquisition module configured to obtain data relating to prior social activity of the subject person; a processing module configured to automatically make a determination of one or both of: a set of personality traits of the subject person; and a social networking status of the subject person, wherein said determination is made at least in part on the basis of said obtained data; a categorization module configured to automatically categorize the subject person based on said determination; and a guidance module configured to automatically provide a set of parameters for guiding interaction with a subject person based on said automatic categorization.

In accordance with another aspect of the present technology, there is provided an apparatus for guiding interaction performed by an agent within a predetermined organization, the apparatus comprising: an input module configured to receive a proposed communication submitted by the agent; a processing module configured to assess a set of personality traits conveyed by said communication, the processing module configured to automatically compare the assessed set of personality traits to a subject set of personality traits prescribed by the organization, the processing is further configured to automatically identify one or more phrases within the communication which cause the assessed set of personality traits to differ from the subject set of personality traits; and an adjustment module configured to provide feedback to the agent to adjust the identified one or more phrases, to automatically adjust the proposed communication in order to more closely match the set of prescribed personality traits, or both.

In accordance with another aspect of the present technology, there is provided a computer program product comprising a computer readable medium storing computer executable statements and instructions thereon that, when executed by a computer, perform operations for guiding interaction with a subject person, the operations comprising: obtaining data relating to prior social activity of the subject person; automatically making a determination of one or both of: a set of personality traits of the subject person; and a social networking status of the subject person, wherein said determination is made at least in part on the basis of said obtained data; automatically categorizing the subject person based on said determination; and automatically providing a set of parameters for guiding interaction with a subject person based on said automatic categorization.

In accordance with another aspect of the present technology, there is provided a computer program product comprising a computer readable medium storing computer executable statements and instructions thereon that, when executed by a computer, perform operations for guiding interaction performed by an agent within a predetermined organization, the operations comprising: receiving a proposed communication submitted by the agent; automatically assessing a set of personality traits conveyed by said communication; automatically comparing said assessed set of personality traits to a target set of personality traits prescribed by the organization; automatically identifying one or more phrases within the communication which cause the assessed set of personality traits to differ from the target set of personality traits; and automatically providing feedback to the agent to adjust the identified one or more phrases.

### BRIEF DESCRIPTION OF THE FIGURES

These and other features of the technology will become more apparent in the following detailed description in which reference is made to the appended drawings.

FIG. 1 illustrates an apparatus provided in accordance with one embodiment of the technology.

FIG. 3 illustrates an apparatus provided in accordance with another embodiment of the technology.

FIG. 4 illustrates extraction and analysis of data to determine personality attributes, in accordance with one embodiment of the technology.

FIG. 5 illustrates personality profiling and use of a personality profile, in accordance with one embodiment of the technology.

FIG. 6 illustrates review of outgoing messages using personality profile analysis, in accordance with one embodiment of the technology.

FIG. 7 illustrates display of personality profile and influence, in accordance with one embodiment of the technology.

FIG. 8 illustrates targeting of marketing efforts based on personality profiling, in accordance with one embodiment of the technology.

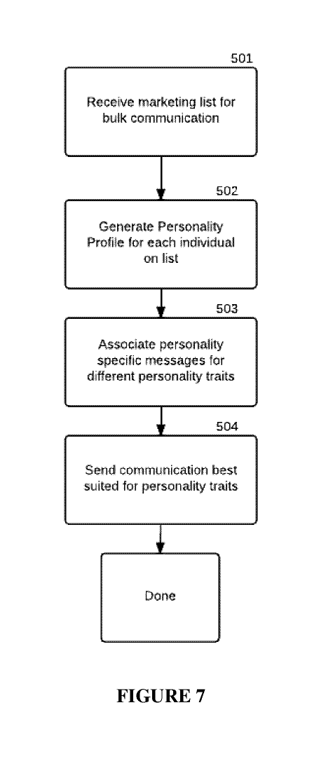

### DETAILED DESCRIPTION OF THE TECHNOLOGY

### Definitions

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this technology belongs.

An aspect of the present technology provides a method for guiding interaction with a subject person, such as a business customer or potential customer. The method comprises identifying the subject person and obtaining data relating to prior social activity of the subject person. For example, data relating to online activity of the subject person may be obtained from social networking websites, public forums, or other communications to which access is possible. The data may be retrieved from its sources on the Internet in real time or retrieved from a database. The method further comprises automatically making a determination of one or both of: a set of personality traits of the subject person; and a social networking status of the subject person. The set of personality traits may be determined at least in part by processing the obtained data. The method further comprises automatically categorizing the subject person in one or more dimensions based on said determination. The method further comprises automatically providing a set of parameters for guiding interaction with a subject person based on said automatic categorization. For example, customized notes or scripts may be provided to a call center agent based on the categorization, certain marketing approaches may be employed based on the categorization, or the like.

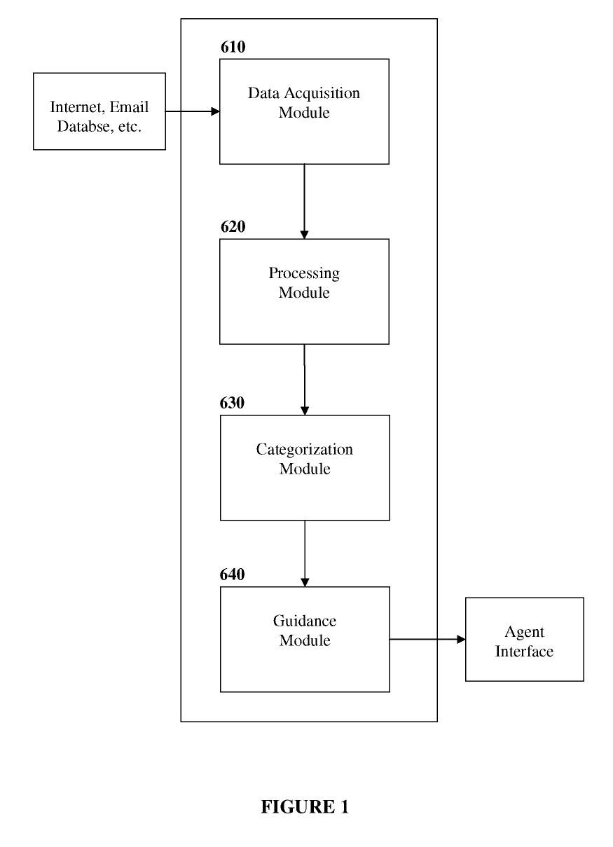

Another aspect of the present technology provides an apparatus configured for guiding interaction with a subject person. Referring to FIG. 1, the apparatus comprises a data acquisition module 610 configured to obtain data relating to prior social activity of the subject person. The apparatus further comprises a processing module 620 configured to automatically make a determination of one or both of: a set of personality traits of the subject person; and a social networking status of the subject person. The determination is made at least in part on the basis of said obtained data. The apparatus further comprises a categorization module 630 configured to automatically categorize the subject person based on said determination. The apparatus further comprises a guidance module 640 configured to automatically provide a set of parameters for guiding interaction with a subject person based on said automatic categorization.

The apparatus may comprise one or more computing devices, such as servers, operatively coupled to various data sources such as the Internet and also operatively coupled to one or more user interfaces. General-purpose computing devices may be configured to provide the functionality of the various modules mentioned above, for example via software or firmware or a combination thereof. The computing devices may be configured to obtain data relating to prior social activity of a subject person, for example by performing directed searches of “crawling” of relevant social networking websites, news or Twitter™ feeds, email databases, and the like. The computing devices may utilize data connections to the various data sources for this purpose. In some embodiments, the computing devices may comprise and maintain one or more databases of information related to various subject persons. The computing devices may further be configured to process data using various processing routines, wherein instructions for executing the processing routines may be retrieved from memory and executed, thereby causing the computing devices to operate as a specialized processing apparatus. The computing devices may further provide output to agents via a user interface, for example in the form of on-screen text output, multimedia output, or the like. In some embodiments, the computing devices may provide output directly to subject persons, for example in the form of automatically generated emails, responses to social networking posts, or the like.

Another aspect of the present technology provides a method for guiding interaction performed by an agent within a predetermined organization. The method comprises receiving a proposed communication submitted by the agent, such as an email, text message, advertising mailout, social media post, newsletter, blog post, or the like. The method further comprises automatically assessing a set of personality traits conveyed by said communication. Automatic assessment may comprise processing selected portions or all of the language of the proposed communication to determine possible personality traits. The method further comprises automatically comparing the assessed set of personality traits to a subject set of personality traits prescribed by the organization. In some embodiments, the prescribed personality traits may be set as part of a brand of the organization. In some embodiments, the prescribed personality traits may be adjusted based on an assessed personality of a subject person to whom the proposed communication is addressed. For example, the prescribed personality traits may be part of the set of parameters for guiding interaction with the subject person, as discussed above. The method further comprises automatically identifying one or more phrases within the communication which cause the assessed set of personality traits to differ from the subject set of personality traits. The method further comprises automatically providing feedback to the agent to adjust the identified one or more phrases. For example, phrases to which changes are recommended may be highlighted, along with annotations indicating a subject personality trait to be conveyed or one or more recommendations for language. The agent can then adjust the proposed communication accordingly and may re-submit it for further automatic assessment. Additionally or alternatively, the method may comprise automatically adjusting the proposed communication in order to more closely match the set of prescribed personality traits.

Another aspect of the present technology provides an apparatus for guiding interaction performed by an agent within a predetermined organization. Referring to FIG. 2, the apparatus comprises an input module 710 configured to receive a proposed communication submitted by the agent. The apparatus further comprises a processing module 720 configured to assess a set of personality traits conveyed by said communication. The processing module may be configured to process selected portions or all of the language of the proposed communication to determine possible personality traits. The processing module is further configured to automatically compare the assessed set of personality traits to a subject set of personality traits prescribed by the organization and automatically identify one or more phrases within the communication which cause the assessed set of personality traits to differ from the subject set of personality traits. The apparatus further comprises an adjustment module 730 configured to provide feedback to the agent to adjust the identified one or more phrases. Additionally or alternatively, the adjustment module 730 may be configured to automatically adjust the proposed communication in order to more closely match the set of prescribed personality traits.

Various embodiments of the present technology provide a method and apparatus for an organization to use personality profiles to better communicate with their clients. Communication may comprise correspondence that impacts how the organization may be viewed, for example publicly. This may include email, SMS, chat, Facebook™, or Twitter™, but may further be extended to additional or all organization communications. A personality profile may comprise a list of traits that may include the Big Five (openness, conscientiousness, extraversion, agreeableness, and neuroticism), Myers Briggs (Extraversion/Introversion, Sensing/iNtuition, Feeling/Perceiving, Thinking/Judging), and/or other taxonomies that describes human personality traits in a descriptive model.

Embodiments of the present technology facilitate providing organizations with an improved ability to communicate with their customers as individuals with known human characteristics, by determining said characteristics and adjusting communication in light of same. Further, some embodiments facilitate allowing the organization to determine its own personality represented in communications to give a metric to measure itself by and to better reflect the message it is trying to express.

In some embodiments, when a subject person such as a customer engages an organization through one of a list of social or private communication tools, server systems are configured to construct a personality profile for the subject person if one does not exist already, and to present this to agents within the organization so they are given a more familiar human representation of the subject person. By using this human profile of the subject person an agent can communicate with the subject person on their level, namely in a manner that aligns with the subject persons personality profile.

In some embodiments, when a business agent or other member of an organization is communicating a message to a customer, the present technology provides a metric to measure if the communication meets a corporate standard beyond spelling and grammar By using personality profiling, an organization may determine what personality traits are desirable to exhibit. Once these traits are identified, a personality profiler may be configured to review proposed outgoing communications and to generate a report to be provided to the writer of the text showing any questionable content, words or phrases that do not express the standards set by the organization, or the like. In this manner, a corporate personality standard can be maintained substantially regardless of the writer of the communication on behalf of the organization.

In some embodiments, when a subject person, such as a customer engages in social media around an organization's brand or area of interest, the present technology is configured to facilitate identifying the subject person and their personality traits and social networking status. Personality profiling is performed to assist in providing insight into the subject person's field of reach, mental stability and other traits, which may be used in guiding how to engage with the subject person. Improved knowledge of the subject person may be used to guide interaction between the organization and the subject person in a manner that increases the probability of desired outcomes. This knowledge related to determined personality traits of the subject person may be used to encourage the subject person to advocate the organization's product or message or to recognize if the subject person poses a threat to the organization. Embodiments of the technology may be used by the organization to manage their social image.

In various embodiments, when performing mass communications to customers, for example related to a sales initiative or informational initiative, multiple versions of a given message may be created for different target groups, and targeted based on assessed personality traits, social networking status, or both. For instance, some personalities are driven by feeling while others may be driven by thought. For this reason the same materials may not work as effectively on both of these types of personalities. Personality profiling may be performed in order to identify the different personalities within a group of subject persons, such as a customer base. Specialized materials may then be prepared and provided to identified subgroups of subject persons. The specialized materials may be crafted with personality type in mind in order to to increase the chance the organizational message is more likely to be received by a given subgroup. This crafting of the materials, for example sales scripts or organization details, may result in increased sales or increased awareness of organizational information, for example. The specialized materials may further be analyzed and adjusted in order to project a certain “personality” of the organization which is expected to be favourably received by a target subgroup.

In some embodiments, a subject person's personality type may be defined in terms of an established taxonomy such as Big Five™ or Myers Briggs, or another taxonomy which categorizes personality types into groups and/or by scale. To determine personality traits a subject person's social networking and other communications may be dissected into factors which may potentially be unique to a given type of communication. A machine learning system may be implemented using supervised learning and a set of qualitative values to determine Once personality type has been determined a personality profile may be determined, the personality profile potentially including plural personality type indicators. In various embodiments, computing processes for determining personality profiles and related interaction guidance parameters are run on local or remote server systems for use in client systems for improved customer communication.

In some embodiments, the server system is configured to progressively profile subject persons as new social and other media information is being obtained, and potentially as interaction with a subject person proceeds via an agent. Progressive profiling may be performed in real-time as data is generated or profiled may be performed on a scheduled basis.

In some embodiments, when an agent is communicating with a customer or other subject person having a predetermined personality type through a communication vehicle (email, twitter, chat, etc.), a profile for that subject person is developed using their personality type. This personality type coupled with corporate best practices for communicating with this personality type may be presented to the agent so that the most effective results from the organization's perspective could be achieved.

In some embodiments, the present technology may be applied to determine best practices in messaging for the purposes of marketing to personality types. For example, personality can influence the response a customer has to advertising and messaging which is from an organization. As such, by using embodiments of the method and apparatus according to the present technology, conversions between an organization and a potential client can be based on personality type, and then based on this interaction and tendencies of a particular client “subject person” having a determined personality type, profiling of that personality type together with their respective tendencies can be performed. For example, preference in advertisement styles, abstract or concrete, can be used to enhance a customer's purchasing habits. For example, there can be a correlation between personality type and preference towards creative (abstract) or analytical (concrete) communication styles. As such, the instant technology can be configured to determine individual personality types, and subsequently create one or more rules or a set of rules that can be used to guide outbound marketing (for example messaging, emails or the like) so that it correlates with the personality type of the individual or individuals who are receiving this marketing material. In this manner, there can be an increased likelihood of the success of the marketing material, for example resulting in a purchase.

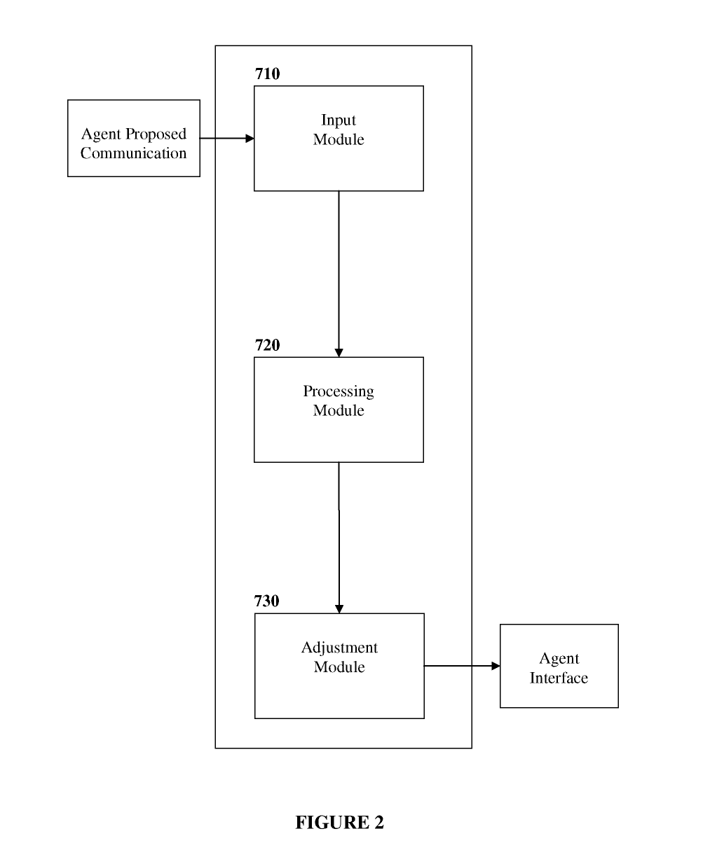

FIG. 3 illustrates how personality type can be extracted from social and private communications, in accordance with embodiments of the present technology. Using a host of different communication platforms, specific factors are extracted and used in a machine learning system. The system can be trained to extract personality traits for subject persons. These traits may be used to build the personality profile for a subject person. In 101a-101f a variety of different possible communication platforms are defined from which to extract factors for machine learning, for example. At a factor analyzer 102 server systems are used to extract these factors from the various communication platforms. Once these factors are extracted a machine learning system 103, may use these extracted factors to determine the personality traits of a subject person. As will be readily understood by a worker skilled in the art, a variety of different machine learning methods may be applied to train the system to learn personality traits. Personality traits may also be determined through statistical analysis. The machine learning system may then determine the personality traits 104 and create a personality profile 105 by joining all the determined traits together for each subject person. The personality profile 105 is the output of the process, where this personality profile could be used in this technology to implement one or more of the possible embodiments where an organization could use personality profiles to better communicate with their customers or other subject persons.

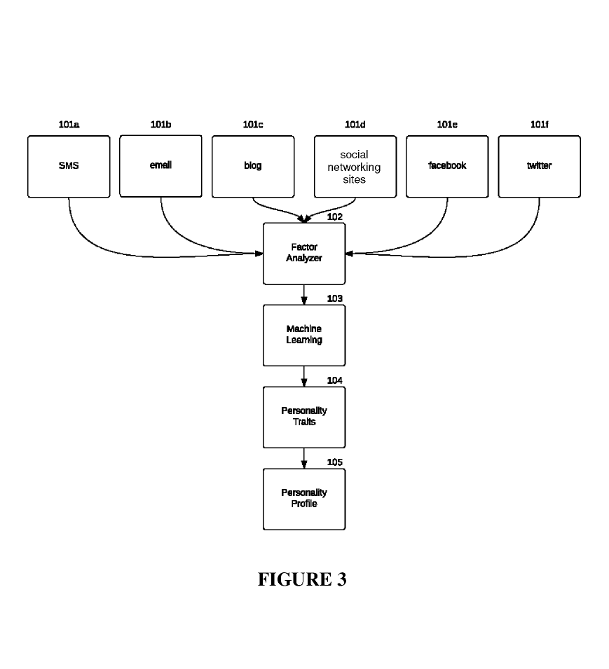

FIG. 4 illustrates how a business agent can receive a personality profile of the subject person they are dealing with, in accordance with embodiments of the present technology. In 201 a communication line is opened between a business agent and a subject person, such as a customer. If the subject person has not been identified it will be necessary to do so in order to retrieve their personality profile. Some of these steps may be omitted or rearranged or adapted in various ways. In general if the personality profile were unknown it would be necessary to determine the subject person's identity at 202 and 203 and then determine the personality profile as in 204 and 205. Once the personality profiler, for example the subsystem that uses machine learning to determine a subject person's personality profile, determines the personality profile this information is displayed to the business agent 206. The agent may be trained to understand how to conduct the interaction with the subject person based on these determined personality traits, or the agent may be given specific guidance in the form of interaction notes, for example. In some embodiments, there may be a legend provided, which may include personality profile specific scripts for an organization or at least descriptions of personality traits to inform the business agent as to how to interact with this subject person, given the determined personality profile.

As an example, a business agent identified above in relation to FIG. 4, can be a person situated at a call centre, a help desk, a live chat desk or the like. In these types of situations, the business agent is able to discuss and provide information or guidance, for example answers, support or other information, in a manner that is aligned with the personality profile of the subject person with whom they are speaking For example, when a subject person is calling a call centre or a help desk, there is typically a level of frustration due to wait times and other issues. When the business agent does commence discussion with the subject person, this conversation can be enhanced and the frustration level of the subject person can be diffused by the business agent interacting with the subject person in a manner that aligns with the subject person's personality profile. This enhancement of the interaction of the subject person with the business agent at the call centre, can provide the organization associated with the call centre with an improved image regarding customer satisfaction which may translate into additional sales or other positive organization rankings, for example recommendations or approval rating.

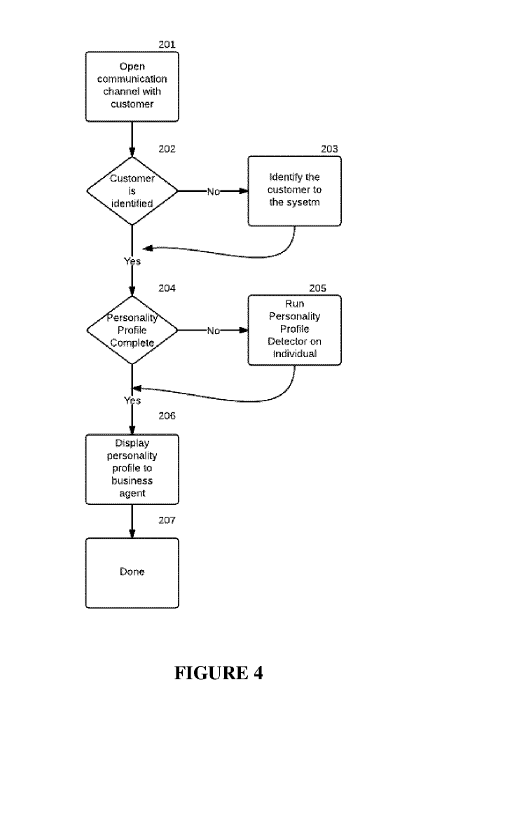

FIG. 5 illustrates how personality profiling may be used when a business agent or other person within the business wants to communicate to a subject person, in accordance with embodiments of the present technology. Just as people have personalities, a business may be made to exhibit an apparent personality through its communications and activities. Using a personality profiler, communications sent from a business may be audited to show where language, words and phrases, express the wrong business image as pertaining to perceived personality. These standard parameters or personality specific parameters would typically be selected by the business, thereby enabling a consistent perceived personality exhibited by communications received from the business. While communications going out are currently reviewed for spelling and grammar, the present technology may facilitate automatically reviewing a written message for apparent personality traits, for example conscientiousness and openness. At 301 a personality profiler may review the written text to be sent out from the organization. At 302 and 303, if the message did not meet standards, a breakdown of issues with the message would be highlighted and sent back to the writer. Once it was approved by the system at 305 the message may be released. This process of review may be applied to a publishing process for a content management system (CMS), where text and messages would need to be validated by the organization before it can be made public, or be accessible to the public.

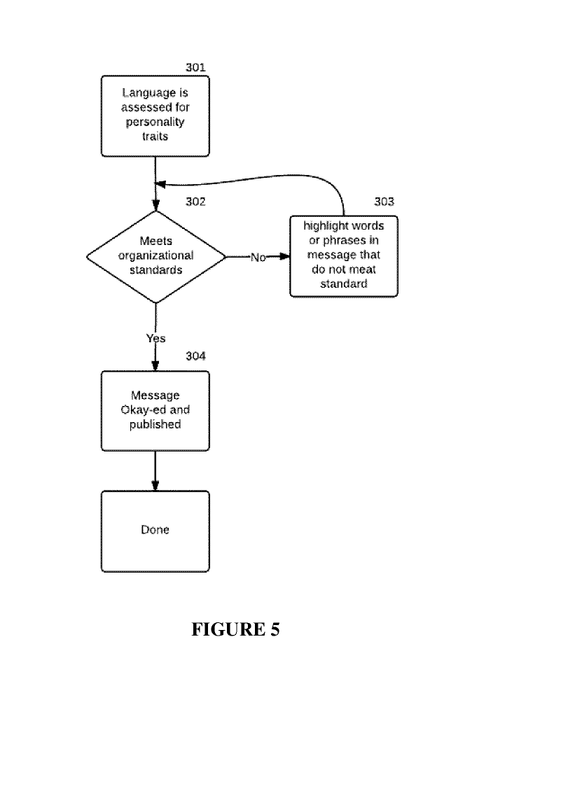

FIG. 6 is a flow diagram illustrating determining a subject person's reach and influence based on personality type, prior to subsequent operations, in accordance with embodiments of the present technology. For example, certain personality types may help to determine a subject person's reach and influence in their social sphere. Through this determination of a subject person's influence, it is possible to use this information for marketing campaigns or determining potentially attractive product advocates or a situation where it is beneficial to the business to determine a subject person's reach and influence. From a negative perspective certain personality traits may be used to determine organizational adversaries to their brand or product or to other situations where a subject person could have negative impact to the organization. At 401 someone within the organization accesses a subject person's personality profile to determine influence. Once the subject person is identified at 402 and 403, the subject person's personality profile is retrieved 404 or created 405 and information based on the personality profile is provided for use in serving the business needs 406.

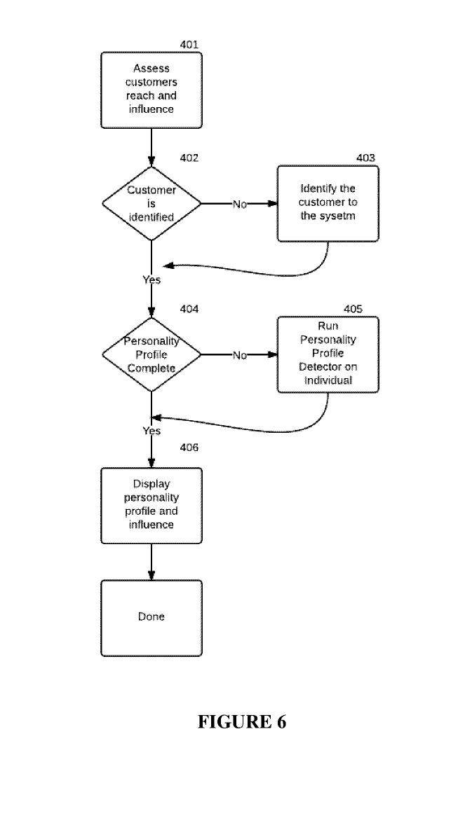

FIG. 7 is a flow diagram illustrating use of personality profiling to market to the different personality traits in a targeted manner, so as to potentially enhance an organization's message, in accordance with embodiments of the present technology. It has been shown that personality affects how we purchase and how we absorb information. It may therefore be advantageous to an organization to create different materials based on personality traits to increase sales or brand awareness or a need that the business has to get a message out. At 501 a marketing list is received to which an organization wants to send a message. At 502 personality profiles are generated for each of the contacts on the marketing list, which may be performed by a server system or other computing system. Once the personalities or determined, personality specific information could be associated with each of the contacts (subject persons) on the list as per their personality 503. At 504 the message is sent out to the contacts thereby completing the process.

### Data Acquisition

Embodiments of the present technology comprise obtaining data relating to prior recorded social activity, typically online activity, of a subject person. In various embodiments, it is desired to capture data indicative of behaviour of the subject person in situations where they are unconcerned or in some cases unaware that their activities are being monitored. It is observed that people will often adjust their behaviour if they know they are being monitored by an outside party to the conversation. In some embodiments, data is therefore collected surreptitiously. In other embodiments, a measurement of the extent to which the person is aware that they are being monitored may automatically be made, the collected data may be tagged with said measurement, and subsequent processing of the data may be performed taking into account the associated measurement.

In some embodiments, permission may be requested and obtained from the subject person for access to private data, such as emails, private or semi-private social networking posts, recorded text chats, or the like. In some embodiments, the obtained data may be publicly available data, or data obtained via an organization to whom the subject person has previously given the appropriate content rights, for example in the form of agreement with a statement of terms and conditions relating to content.

In some embodiments, data relating to prior activity of the subject person may be obtained as needed from various websites, public and in some instances private accounts, and the like. In some embodiments, data relating to prior activity of the subject person may be obtained at one or more time instances and stored in a separate database. The data can then be drawn from the database as needed for processing.

### Types of Data

In some embodiments, the obtained data comprises linguistic or semantic data. For example, linguistic data may include written content generated by the subject person, whether private, directed toward another individual, or directed to a specific or general audience.

In some embodiments, the obtained data comprises behavioural data. For example, behavioural data may include responses of the subject person to specific situations, history of online activity, history and extent of interaction within a social network, historic amount of content generated by the subject person, and the like.

In some embodiments, the obtained data comprises structural data. For example, structural data may include network data related to a social network with which the subject person interacts. This may include a list of first degree network contacts of the subject person, a list of second degree contacts (contacts of contacts), and so on, the number of contacts that each n^{th} degree contact has, and the like. This may also include historic intensity of interaction occurring between contacts, a history of potentially changing contact structure within the social network, and other structural data.

Other sources of data that could potentially be mined in order to evaluate a personality type of a subject person would be readily understood by a worker skilled in the art.

### Sources of Data

Non-limiting example sources of data for assessment of a subject person's personality type can include Twitter™ feeds, Facebook™ pages, social networking sites, SMS messages, emails sent by the subject person, blog posts, and the like. Further sources of data can prior written, verbal, or transcribed communication with the organization using the data or an affiliate organization. Other sources of data may include responses to surveys and questionnaires, types of websites visited, data related to stored cookies, responses to online advertisements, personality trends among friends and associates, and the like.

### Data Processing

Embodiments of the present technology comprise processing the obtained data in order to determine a personality trait, or a personality profile comprising a plurality of personality traits.

There are a variety of existing taxonomies used in measuring and categorizing personality. These include taxonomies such as the Big Five Factor Model and Myers-Briggs and the like. Other taxonomies may be used, for example to describe deceptiveness, altruism, Machiavellianism, self-esteem, and anger response. It should be understood that virtually any taxonomy or combination of taxonomies can be utilized in the instant technology. Typically. a taxonomy will have sufficient structure so that measurement and categorization of personality may be performed by applying a predetermined algorithm The algorithm may be a set of if-then statements, an automated expert system, or the like. Thus, while a taxonomy may ultimately have been developed by trained professionals, application of the taxonomy may be performed by applying the codified algorithm Such taxonomies propose a link between certain behaviours and one or more personality traits. Personality traits may correspond to categories, with each trait being exhibited by a presumably significant portion of a population. A personality trait can be inferred from observed behaviours in actual or hypothetical situations. Once traits have been inferred, they may be used to predict behaviours in future situations. Inference of personality traits and subsequent behavioural predictions are typically not 100% accurate, however, even an inference or prediction which is more likely to be correct than not, or even most likely to be correct out of a range of alternatives, can be useful in various embodiments, particularly when dealing with substantial numbers of situations or individuals.

In some embodiments, the obtained data includes a variety of network metrics that may be processed in order to determine social networking status based on structural data. For example, such metrics may include the number of contacts within one or more social networks, the number of followers of a blog or Twitter™ feed or other public or semi-public content outlet, and the like. In addition to number of contacts, other social networking measures may be determined, such as eigenvector centrality, online influence for example as measured by Klout™, network indegree and outdegree, influence as a hub or authority, retweeting activity, and the like. Various other social networking metrics may be used as would be readily understood by a worker skilled in the art.

In some embodiments, characteristics such as whether the subject person has or has not granted permission to access private data, or measures which the subject person has taken to protect their privacy, may itself be used as an indicator of personality type of the subject person. In some embodiments, an extent to which the subject person may have taken actions and the type thereof in order to limit accuracy of some personal or even non-personal information may be used as an indicator of personality type of the subject person. For example, if the subject person has posted content with the apparent intent of misleading personality profiling algorithms, this may be used as evidence that the subject person has deceptive or hostile tendencies.

In various embodiments, data processing may comprise feature extraction. As will be readily understood by a worker skilled in the art, subsequent data processing complexity may be reduced if personality is determined based on features extracted from input data, rather than on the raw input data itself. Feature extraction may be performed to provide various features such as, but no limited to, those listed below.

### Extracted Features

In some embodiments, extracted features may comprise linguistic enquiry and word count features. Such features may include word count, measure of words per sentence, measure of word length, e.g. number of words longer than six letters, occurrence of first person singular pronouns, and the like. In some embodiments, extracted features may relate to psychological process, for example affection or emotion process, positive emotion, anger, or the like. In some embodiments, extracted features may relate to relative orientation of the subject person. Such features may include occurrence of references to time, verb tense (e.g. past or present), spatial references (e.g. up or down), and the like. In some embodiments, extracted features may relate to occurrence of references related to personal concerns, such as occupation, school, work, leisure, sports, entertainment, financial issues, metaphysical issues, religion, death, and the like. In some embodiments, extracted features may include other grammatical features such as occurrence of punctuation (e.g. periods and commas), and occurrence of colloquialisms, expletives, non-fluencies, fillers, and the like.

In some embodiments, extracted features may include features, such as number of letters, phonemes, syllables, Kucera-Francis metrics, Thorndike metrics, Brown metrics, familiarity rating, concreteness rating, imageability rating, Meaningfulness Colorado Norms, Meaningfulness Pavio Norms, and the like.

In various embodiments, features may be extracted using natural language processing. Various natural language processing functionalities as provided in existing programming language libraries may be employed for this purpose.

In some embodiments, extracted features may include platform specific features, that are relevant only for certain types of communication. For example, for Twitter™ and similar services, extracted features may include number of followers, number of feeds being followed, number of feeds being followed which also follow the subject, number of tweets, frequency of tweets, number or frequency of retweets, and the like. For Facebook™ and similar services, extracted features may include number of contacts or friends of a given type, frequency of contact, number or frequency of interactions such as own wall posts, other wall posts, comments, pokes, and likes, number of photos uploaded, number or frequency of photo tagging events involving the subject, and the like.

### Statistical Model Overlay

In various embodiments, data, such as extracted feature data, is input into a statistical model, and statistical analysis is employed to determine correlations within the given data sets, and to identify personality traits in accordance with one or more given psychological taxonomies. In various embodiments, a psychological taxonomy is defined as a distinct list of traits descriptive of personality by group, scale, or a combination thereof. A given taxonomy may receive as input various extracted features and provide as output various traits descriptive of personality, based on previously established correlations.

In some embodiments, a taxonomy or statistical model may be regression based, that is providing output indicative of degree to which one or more personality traits are present. In some embodiments, a taxonomy or statistical model may be classification based, that is providing output indicative of which one or more personality traits are present and which are not. In some embodiments, a taxonomy or statistical model may be a hybrid between regression-based and classification-based. In some embodiments, some traits are determined using a classification-based model while others are determined using a regression-based model.

In various embodiments, machine learning methods may be used to apply a taxonomy. For example, supervised machine learning may be employed to generate classification functions for determining personality traits based on certain types of input data such as extracted feature data. Machine learning may be used to determine correlations between personality traits and behaviours. Appropriate training data may be input into the machine learning system in order to develop the classifier functions, as would be readily understood by a worker skilled in the art.

In some embodiments, supervised machine learning may be employed to develop a set of classifier functions for determining correspondences between extracted language features and personality traits. Classifier functions may be developed using appropriate sets of training data, and may classification-based or regression-based.

Various personality traits may be identified using the above-described techniques. For example, personality traits specified in taxonomies such as Big Five™ and Myers-Briggs may be identified, and/or personality traits such as Openness, Conscientiousness, Extraversion, Agreeableness, Neuroticism, and the like.

A set of personality traits and social networking status indicators may be used to automatically categorize a subject person. Categorization allows the “type” of person to be identified without describing everything about the person. Categorization should be broad enough so that the number of categories is kept within a reasonable bound. That is, since actions will be taken according to the categorization, the number of actions should be limited so that contingency action plans are not prohibitively complex or extensive. Categorization should also be narrow enough that the categorization is useful and meaningful.

In some embodiments, automatic categorization comprises categorizing the subject person as a potential advocate or a potential detractor with respect to a given organization or issue or product or the like. In particular, the organization may be an organization seeking and/or generating guidance on how to interact with the subject person, as detailed below.

In some embodiments, automatic categorization comprises categorizing the subject person in terms of their potential level of impact within a community as an advocate, detractor, or both. In particular, the potential level of impact may be categorized with respect to advocacy or detraction from the above-mentioned organization.

In some embodiments, a taxonomy may be codified as follows. A set of input behaviours, such as features extracted from subject person's communications, may be related to a set of personality traits through a set of probability inferences, for example a probability of accuracy associated with each of the personality traits. For example, individual input behaviours or certain combinations of input behaviours may be associated with one or more personality traits. In some embodiments, the association may include probabilities. For example, if a certain input behaviour or set of input behaviours is observed, then the taxonomy may specify that the subject has personality traits T₁, T₂, etc. with corresponding likelihoods p₁, p₂, etc. In some embodiments, probabilistic methods such as Bayesian networks may be employed to codify such a taxonomy. Taxonomies of various complexities may be codified, for example with intermediate nodes between input behaviours and personality traits.

Guiding Interaction with Subject Person

Embodiments of the present technology comprise automatically providing a set of parameters for guiding interaction with a subject person based on the automatic characterization and categorization of the subject person with respect to personality traits, social networking status, and the like. The parameters may be customized for use by a particular organization seeking to interact with the subject person, for example as a customer or potential customer, or as an existing or potential partner, investor, employee, contractor, or the like.

In some embodiments, the set of parameters may comprise notes or one or more scripts provided to an agent of the organization who is tasked with interacting with the subject person via voice or text. For example the agent may operate out of an inbound or outbound call center, a live chat support center, or the like. The agent may interact directly with the subject person via telephone, chat, text message, email, or other means. In some embodiments, the agent may produce marketing material for providing to groups of subjects. In some embodiments a group of subjects may be associated with particular personality traits or range of personality traits to which the marketing material is correlated.

In some embodiments, the set of parameters may comprise directions for automatic selection of online advertisements for displaying to the subject person.

In some embodiments, the set of parameters may comprise directions for automated interaction with the subject person, for example via an automated customer service program or “bot.”

In some embodiments, the present technology is configured to facilitate operation of an electronic communication platform that uses text to interact with subject persons. Text used for interacting with the subject persons, such as responses to queries, may be generated automatically based on the determined personality type of the subject person. For example, automatically generated text may be provided via Twitter™, email auto-responses, SMS text messages, postings on social media platforms, or other methods by which interaction with clients takes place using automation.

In some embodiments, the present technology is applied to systems where interpersonal exchange is required. Such exchange may involve a call between an agent and the subject person. For example, the agent is provided with the detected personality type of the subject person and notes detailing recommendations for interacting with the subject person based on personality type may be provided, based on best practices. In some embodiments, a script may be provided for interacting with the subject person that is pre-configured to the personality type. The script may include one or more contingency plans, for example including questions to ask and script portions to read out based on the subject person's response.

In various embodiments, the present technology may be employed in communications such as marketing, advertising, sales, survey taking, technical support, inbound communication, outbound communication, referral follow-ups, cold calls, cross promotions, social media presence and response, and the like.

In some embodiments, the present technology comprises identifying subject persons that would most likely and least likely provide influence or impact, based on personality type. Influence or impact may be defined as a person's measured ability to connect with and communicate a message to one or more people, either in person or through mediums such as the Internet, television, radio, or mobile devices.

In some embodiments, the present technology comprises adjusting interaction with a subject person based on one or more of: a level to which the subject person may be a potential advocate or detractor for a given organization, person, place, product or issue, and a potential impact of the subject person as an advocate or detractor. Determining whether the subject person may be an advocate or detractor may be based at least in part on personality type. For example, a subject person who is identified as having potentially strong impact as an advocate for an organization may be given preferential treatment. In addition for example, a subject person who is identified having being potentially negative impact may be handled in an alternate manner in order to mitigate this potentially negative impact. For example, based on automated personality profiling, certain phrases may be identified, and subsequently mentioned or avoided in order to gain or retain favour with the subject person.

In some embodiments, the present technology identifies one or more motivators, such as intrinsic or extrinsic motivators, that are likely applicable to a subject person, wherein the identification is based on a predetermined correlation between motivators and personality type. Such correlations may be based on prior psychological research and encoded into a computing system. One or more of the identified motivators may then be used in order to appeal to the subject person and influence them to act or respond in a desired way.

In some embodiments, the personality assessment is based on knowledge from Myers-Briggs research that Feeling personality types prefer to immerse themselves into a situation and “feel it out,” whereas Thinking personality types prefer to think before acting. Based on this, embodiments of the present technology may be used to appeal to a subject person in a different way depending on personality type. For example, the Thinking personality type may be given hard facts such as mileage details for a prospective car purchase, while the Feeling personality type may be given evocative imagery such as an image of the car driving into the sunset.

In some embodiments, the personality assessment is based identifying personality traits that are associated with a willingness to complain. Subject persons having such personality traits as well as social network influence may be identified with a corresponding numerical risk factor and dealt with in a manner that avoids cause for complaint.

### Adjusting Outgoing Communications

In some embodiments, the present technology may be applied to guide interactions performed by an agent, by providing feedback and/or adjustment related to a proposed communication submitted by the agent, in advance of the proposed communication being sent to a subject person or group thereof.

In some embodiments, as the agent is constructing communications either for mass communication or one on one interaction, a server system is configured to review the communications to ensure that they adhere to corporate best standards. These corporate best standards may include personality traits that the business wants to exhibit or traits that have been shown to create more effective communication directed to the business or organization.

In some embodiments, the prescribed personality traits may be adjusted based on assessed personality traits of a subject person to whom the proposed communication is addressed. In some embodiments, the prescribed personality traits may be adjusted based on an assessed social networking status of the subject person. In some embodiments, the prescribed personality traits may be adjusted based on an assessed potential of the subject person to be an advocate or detractor, and their potential level of influence or impact as an advocate or detractor.

It will be appreciated that, although specific embodiments of the technology have been described herein for purposes of illustration, various modifications may be made without departing from the spirit and scope of the technology. In particular, it is within the scope of the technology to provide a computer program product or program element, or a program storage or memory device such as a solid or fluid transmission medium, magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, PL/1, or the like. In addition, each step, or a file or object or the like implementing each said step, may be executed by special purpose hardware or a circuit module designed for that purpose.

It is obvious that the foregoing embodiments of the technology are examples and can be varied in many ways. Such present or future variations are not to be regarded as a departure from the spirit and scope of the technology, and all such modifications as would be obvious to one skilled in the art are intended to be included within the scope of the following claims.

1. A method for guiding interaction with a subject person, the method comprising:
(a) obtaining, by a computer, data relating to prior social activity of the subject person;
(b) automatically making a determination, by a computer, of one or both of: a set of personality traits of the subject person; and a social networking status of the subject person, wherein said determination is made at least in part on the basis of said obtained data;
(c) automatically categorizing, by a computer, the subject person based on said determination; and
(d) automatically providing, by a computer, a set of parameters for guiding interaction with a subject person based on said automatic categorization.

2. The method of claim 1, wherein the method is implemented for guiding interaction with the subject person by a predetermined organization, and wherein said automatic characterization comprises characterizing the subject person as a potential advocate or a potential detractor with respect to said organization.

3. The method of claim 2, wherein said automatic characterization further comprises characterizing a potential level of impact of the subject person with respect to advocating or detracting.

4. The method according to claim 1, wherein the set of parameters includes a script for interaction with the subject person.

5. The method according to claim 4, wherein the script further includes one or more contingency plans based on one or more responses from the subject person.

6. The method according to claim 1, wherein the data relating to social activity is obtained from one or more sources including Twitter™, Facebook™, one or more other social networking sites, short message service (SMS) messages, emails sent by the subject person and blog posts by the subject person.

7. The method according to claim 1, wherein making the determination of a set of personality traits includes a statistical analysis of the obtained data with respect to one or more given psychological taxonomies.

8. The method according to claim 1, wherein making the determination of a set of personality traits includes determining one or more personality traits, wherein one or more of the personality traits has a determined probability of accuracy.

9. The method according to claim 1, wherein making the determination of a set of personality traits is progressively determined as new social activity of the subject person is obtained.

10. The method according to claim 9, wherein the progressive determination of a set of personality traits can be performed in real-time or on a scheduled basis.

11. A method for guiding interaction performed by an agent within a predetermined organization, the method comprising:
(a) receiving, by a computer, a proposed communication submitted by the agent;
(b) automatically assessing, by a computer, a set of personality traits conveyed by said communication;
(c) automatically comparing, by a computer, said assessed set of personality traits to a target set of personality traits prescribed by the organization;
(d) automatically identifying, by a computer, one or more phrases within the communication which cause the assessed set of personality traits to differ from the target set of personality traits; and
(e) automatically providing, by a computer, feedback to the agent to adjust the identified one or more phrases.

12. The method of claim 11, wherein the proposed communication is intended for an identified subject person, the method further comprising adjusting the target set of personality traits based on a set of parameters for guiding interaction with said subject person.

13. The method of claim 12, wherein obtaining said set of parameters comprises:
(a) obtaining data relating to prior social activity of the subject person;
(b) automatically making a determination of one or both of: a set of personality traits of the subject person; and a social networking status of the subject person, wherein said determination is made at least in part on the basis of said obtained data;
(c) automatically categorizing the subject person based on said determination; and
(d) automatically providing the set of parameters for guiding interaction with a subject person based on said automatic categorization.

14. The method of claim 12, wherein said communication is intended for at least one person external to the organization.

15. An apparatus configured for guiding interaction with a subject person, the apparatus comprising:
(a) a data acquisition module configured to obtain data relating to prior social activity of the subject person;
(b) a processing module configured to automatically make a determination of one or both of: a set of personality traits of the subject person; and a social networking status of the subject person, wherein said determination is made at least in part on the basis of said obtained data;
(c) a categorization module configured to automatically categorize the subject person based on said determination; and
(d) a guidance module configured to automatically provide a set of parameters for guiding interaction with a subject person based on said automatic categorization.

16. The apparatus according to claim 15, wherein the processing module is configured to make the determination of a set of personality traits based on a statistical analysis of the obtained data with respect to one or more given psychological taxonomies.

17. The apparatus according to claim 15, wherein the processing module is configured to make the determination of a set of personality traits which includes determining one or more personality traits, wherein one or more of the personality traits has a determined probability of accuracy.

18. The apparatus according to claim 15, wherein the processing module is configured to make a progressive determination of a set of personality traits as new social activity of the subject person is obtained.

19. The apparatus according to claim 18, wherein the progressive determination of a set of personality traits can be performed in real-time or on a scheduled basis.

20. An apparatus for guiding interaction performed by an agent within a predetermined organization, the apparatus comprising:
(a) an input module configured to receive a proposed communication submitted by the agent;
(b) a processing module configured to assess a set of personality traits conveyed by said communication, the processing module configured to automatically compare the assessed set of personality traits to a subject set of personality traits prescribed by the organization, the processing is further configured to automatically identify one or more phrases within the communication which cause the assessed set of personality traits to differ from the subject set of personality traits; and
(c) an adjustment module configured to provide feedback to the agent to adjust the identified one or more phrases, to automatically adjust the proposed communication in order to more closely match the set of prescribed personality traits, or both.

21. The apparatus of claim 20, wherein the proposed communication is intended for an identified subject person, and wherein the processing module is further configured to adjust the target set of personality traits based on a set of parameters for guiding interaction with said subject person.

22. (canceled)

23. (canceled)
